(19) United States
(12) Patent Application Publication
(10) Pub. No.: US 2014/0122342 A1
(43) Pub. Date: May 1, 2014

(54) Host based content security and protection

(71) Applicant: BROADCOM CORPORATION, Irvine, CA (US)

(72) Inventors: Yasantha N. Rajakarunanayake, San Ramon, CA (US); William S. Bunch, Menlo Park, CA (US); Jacob Mendel, Kibutz Givat Brenner (IL)

(73) Assignee: BROADCOM CORPORATION, Irvine, CA (US)

(21) Appl. No.: 13/664,770

(22) Filed: Oct. 31, 2012

Related U.S. Application Data
(60) Provisional application No. 61/719,721, filed on Oct. 29, 2012.

(51) Int. Cl. G06F 21/24

(52) U.S. Cl. 705/59

(57) ABSTRACT

Host based content security and protection. Security is achieved via a third-party device serving as an intermediary or host (e.g., certificate authority (CA)) between two or more user device is associated with two or more users. Any number of security measures may be employed to ensure that the content and/or identity associated with a given user is protected, including on a per communication or content basis. Various authentication, authorization, and accounting (AAA) protocols may be employed to govern the respective sharing of content and/or identity between respective users within the system, and such AAA protocols may be dynamically allocated differently with respect to different pairings of users at different respective times. In addition, with respect to digital rights management (DRM) employed to govern the security of content and/or identity between users, a third-party device (e.g., intermediary) and/or any respective user may establish specific rules for secure content and/or identity communications.

### CROSS REFERENCE TO RELATED PATENTS/PATENT APPLICATIONS

### Provisional Priority Claims

The present U.S. Utility Patent Application claims priority pursuant to 35 U.S.C. §119(e) to the following U.S. Provisional Patent Application which is hereby incorporated herein by reference in its entirety and made part of the present U.S. Utility Patent Application for all purposes:

1. U.S. Provisional Patent Application Ser. No. 61/719,721, entitled “Host based content security and protection,” (Attorney Docket No. BP31011), filed 10-29-2012, pending.

### BACKGROUND OF THE INVENTION

1. Technical Field of the Invention

The invention relates generally to communication systems; and, more particularly, it relates to security and protection of communications between various communication devices within such communication systems.

2. Description of Related Art

Data communication systems have been under continual development for many years. Within certain types of systems, certain types of content may be shared between different respective parties. For example, in the context of certain social networking as may be performed between different respective users, there is little (if any) to no security or assurance of security provided for the content which may be shared by a user via such social networking. As such, certain personal information may unfortunately be compromised when users interact with such systems. Generally speaking, the present state-of-the-art does not provide an adequate or acceptable means by which content may be protected when interacting with various forms of computer networks including those that support social networking. In addition to the failure to provide an adequate or acceptable means to protect content, identity also may not be adequately or acceptably protected when interacting in dealing with such various forms of computer networks including those that support social networking.

### BRIEF DESCRIPTION OF THE SEVERAL VIEWS OF THE DRAWINGS

FIG. 1 and FIG. 2 illustrate various embodiments of communication systems.

FIG. 3 illustrates an embodiment of a third party operating as a security authority for respective communications between communication devices.

FIG. 4 illustrates an embodiment of dynamic secure key allocation among various communication devices.

FIG. 5 illustrates an embodiment of a secure key grant among various communication devices.

FIG. 6 illustrates an embodiment of using at least one authentication, authorization, and accounting (AAA) protocol for various communications between communication devices.

FIG. 7 illustrates an embodiment of dynamic AAA protocol allocation for various communications between communication devices.

FIG. 8 illustrates an embodiment of content preview, security authentication, and selective full content provision among various communication devices.

FIG. 9 and FIG. 10 illustrate various embodiments of methods for operating one or more communication devices.

### DETAILED DESCRIPTION OF THE INVENTION

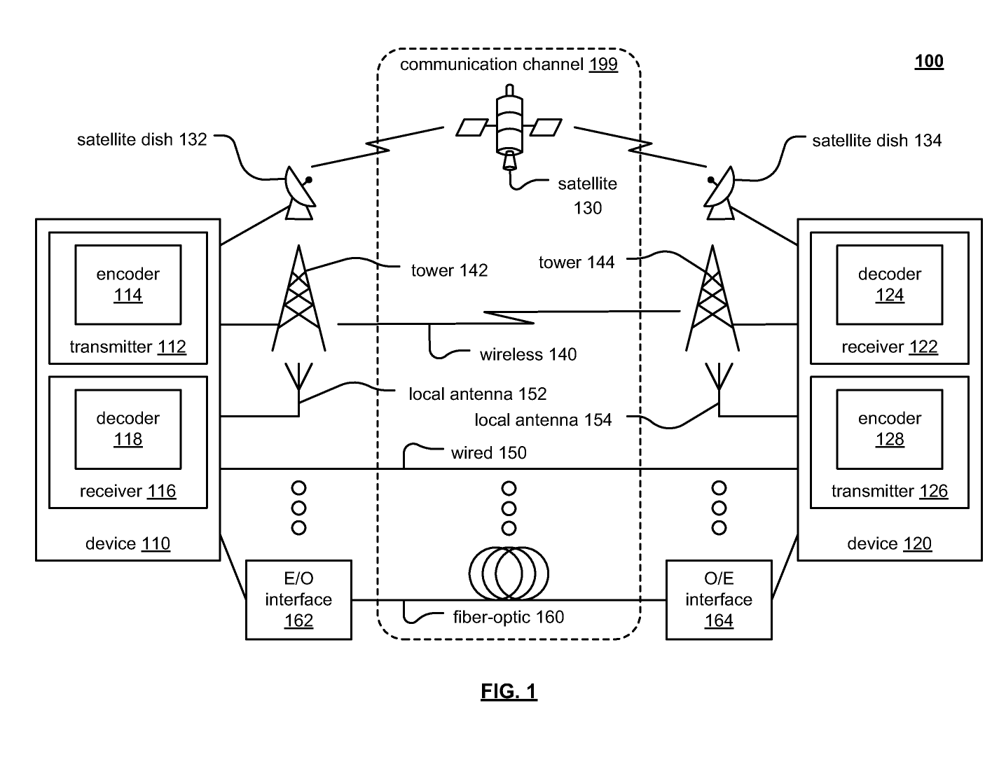

Within communication systems, signals are transmitted between various communication devices therein. The goal of digital communications systems is to transmit digital data from one location, or subsystem, to another either error free or with an acceptably low error rate. As shown in FIG. 1, data may be transmitted over a variety of communications channels in a wide variety of communication systems: magnetic media, wired, wireless, fiber, copper, and other types of media as well.

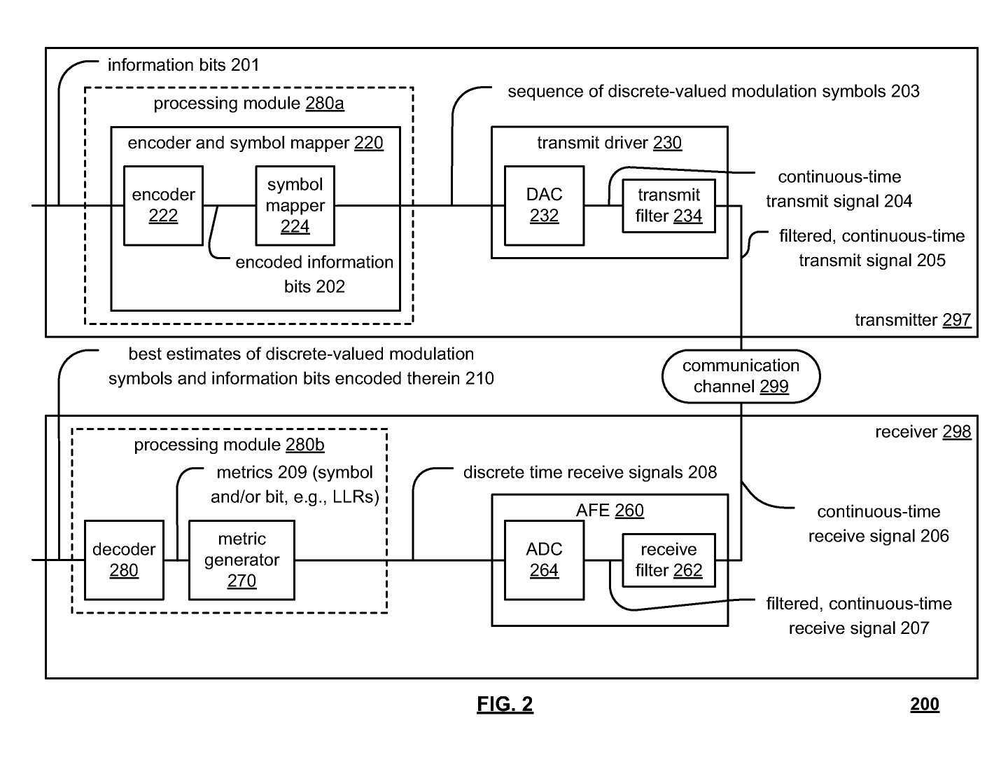

FIG. 1 and FIG. 2 illustrate various embodiments of communication systems, 100, and 200, respectively.

Referring to FIG. 1, this embodiment of a communication system 100 is a communication channel 199 that communicatively couples a communication device 110 (including a transmitter 112 having an encoder 114 and including a receiver 116 having a decoder 118) situated at one end of the communication channel 199 to another communication device 120 (including a transmitter 126 having an encoder 128 and including a receiver 122 having a decoder 124) at the other end of the communication channel 199. In some embodiments, either of the communication devices 110 and 120 may only include a transmitter or a receiver. There are several different types of media by which the communication channel 199 may be implemented (e.g., a satellite communication channel 130 using satellite dishes 132 and 134, a wireless communication channel 140 using towers 142 and 144 and/or local antennae 152 and 154, a wired communication channel 150, and/or a fiber-optic communication channel 160 using electrical to optical (E/O) interface 162 and optical to electrical (O/E) interface 164)). In addition, more than one type of media may be implemented and interfaced together thereby forming the communication channel 199.

It is noted that such communication devices 110 and/or 120 may be stationary or mobile without departing from the scope and spirit of the invention. For example, either one or both of the communication devices 110 and 120 may be implemented in a fixed location or may be a mobile communication device with capability to associate with and/or communicate with more than one network access point (e.g., different respective access points (APs) in the context of a mobile communication system including one or more wireless local area networks (WLANs), different respective satellites in the context of a mobile communication system including one or more satellite, or generally, different respective network access points in the context of a mobile communication system including one or more network access points by which communications may be effectuated with communication devices 110 and/or 120.

To reduce transmission errors that may undesirably be incurred within a communication system, error correction and channel coding schemes are often employed. Generally, these error correction and channel coding schemes involve the use of an encoder at the transmitter end of the communication channel 199 and a decoder at the receiver end of the communication channel 199.

Any of various types of ECC codes described can be employed within any such desired communication system (e.g., including those variations described with respect to FIG. 1), any information storage device (e.g., hard disk drives (HDDs), network information storage devices and/or servers, etc.) or any application in which information encoding and/or decoding is desired.

Generally speaking, when considering a communication system in which video data is communicated from one location, or subsystem, to another, video data encoding may generally be viewed as being performed at a transmitting end of the communication channel 199, and video data decoding may generally be viewed as being performed at a receiving end of the communication channel 199.

Also, while the embodiment of this diagram shows bi-directional communication being capable between the communication devices 110 and 120, it is of course noted that, in some embodiments, the communication device 110 may include only video data encoding capability, and the communication device 120 may include only video data decoding capability, or vice versa (e.g., in a uni-directional communication embodiment such as in accordance with a video broadcast embodiment).

Referring to the communication system 200 of FIG. 2, at a transmitting end of a communication channel 299, information bits 201 (e.g., corresponding particularly to video data in one embodiment) are provided to a transmitter 297 that is operable to perform encoding of these information bits 201 using an encoder and symbol mapper 220 (which may be viewed as being distinct functional blocks 222 and 224, respectively) thereby generating a sequence of discrete-valued modulation symbols 203 that is provided to a transmit driver 230 that uses a DAC (Digital to Analog Converter) 232 to generate a continuous-time transmit signal 204 and a transmit filter 234 to generate a filtered, continuous-time transmit signal 205 that substantially comports with the communication channel 299. At a receiving end of the communication channel 299, continuous-time receive signal 206 is provided to an AFE (Analog Front End) 260 that includes a receive filter 262 (that generates a filtered, continuous-time receive signal 207) and an ADC (Analog to Digital Converter) 264 (that generates discrete-time receive signals 208). A metric generator 270 calculates metrics 209 (e.g., on either a symbol and/or bit basis) that are employed by a decoder 280 to make best estimates of the discrete-valued modulation symbols and information bits encoded therein 210.

Within each of the transmitter 297 and the receiver 298, any desired integration of various components, blocks, functional blocks, circuitries, etc. Therein may be implemented. For example, this diagram shows a processing module 280a as including the encoder and symbol mapper 220 and all associated, corresponding components therein, and a processing module 280 is shown as including the metric generator 270 and the decoder 280 and all associated, corresponding components therein. Such processing modules 280a and 280b may be respective integrated circuits. Of course, other boundaries and groupings may alternatively be performed without departing from the scope and spirit of the invention. For example, all components within the transmitter 297 may be included within a first processing module or integrated circuit, and all components within the receiver 298 may be included within a second processing module or integrated circuit. Alternatively, any other combination of components within each of the transmitter 297 and the receiver 298 may be made in other embodiments.

As with the previous embodiment, such a communication system 200 may be employed for the communication of video data is communicated from one location, or subsystem, to another (e.g., from transmitter 297 to the receiver 298 via the communication channel 299). It is noted that any respective communications herein between different respective devices may be effectuated using any communication link, network, media, means, etc. including those described with reference to FIG. 1 and their equivalents.

Generally speaking, a novel means is presented herein by which a personal digital rights management (DRM) scheme allows for protection of content, identity, etc. associated with various users of any of a number of various forms of computer networks including those that support social networking. For example, certain social networking networks may be associated with Facebook, LinkedIn, MySpace, etc. and generally associated with any data networking or data sets hosted via any of a variety of networks (e.g., the Internet, the cloud, etc.). In such instances, DRM may be employed to allow access to content or identity of one particular user to one or more other users. However, as may be understood herein, the ability to control, restrict, monitor, etc. the times, terms, etc. of use or access to content or identity may be supported. For example, a user may provide for control of content to be shared only to one or more other individual users.

In accordance with the novel manner by which such security is achieved herein, security may be achieved whereby a user may sign individual copies of their content and establish effective DRM for any content that they choose to share as well as their identity. It is noted that such security may be achieved by individual signing of content itself. In other words, each individual portion of content may undergo digital signature by a particular user seeking to ensure the security of the content and/or his/her identity.

In addition, certain usage permissions, access permissions, etc. to content may conditional based upon any of a number of considerations (e.g., proximity of a device corresponding to or operated by a user choosing to share content with location of another device corresponding to or operated by another user, proximity of a device corresponding to or operated by a user to a particularly operable device [such as an access point (AP), a global positioning system (GPS) tracking system, etc.], etc.).

In certain embodiments, a hosting entity of content (e.g., Facebook, LinkedIn, MySpace, etc.) may charge users an additional fee or provide for an alternative form of service (e.g., premium form of service) to provide secure access for a given users content and/or identity.

A variety of means they be employed by which such security may be achieved including the use of individual and respective secure private keys for various users within the system. For example, a shared key to unlock content can be exchanged with the Diffie-Hellman key exchange mechanism or other key verification, etc. A web of trust model may be employed (e.g., whereby a third party such as Facebook, LinkedIn, MySpace, etc.). Such a third party may be operative to authenticate each respective user (e.g., a third party, implemented within the cloud, such as Facebook, LinkedIn, MySpace, etc. can be the Root certificate authority (CA) or any other authorized certificate which has a certificate chain with that third party), Producer and Consumer of content can work, and allows the third party to further maintain its position as the trusted 3rd party in providing the authenticity of the users on both sides.

As may be understood herein, the achievement of security herein is not necessarily exactly the same as (e.g., may even be viewed oppositely as) as a secure sockets layer (SSL) and transport layer security issue. For example, in accordance with operation of a SSL based, a web-site is authenticated by a trusted CA, but the web-site itself has no mechanism to authenticate an individual and respective user or the content provided therefrom. Herein, authentication on an individual user basis may be made for each respective piece of content and/or identity, and the ability to monitor and track to the content provider who is another user in the cloud who has provided or published such content is achieved.

As may be understood with respect to the ever-increasing digital world in which an increasing number of, sometimes, highly personal information may be transmitted via various networks. An extremely high level of content protection and DRM may be viewed is absolutely necessary in certain situations where personal content including that of high value (e.g., medical records, DNA results, etc.) may be publicly hosted. In addition, applications of this type of DRM, and secure content is important for valuable digital content (e.g., birth certificates, social security paperwork, licenses of various types, passports, visa, security clearances, etc.) etc. in the digital age.

In at least one embodiment, various aspects and/or their equivalents, of the invention, specific DRM scheme(s) may be implemented using one or more sets of Crypto++™ (e.g., open source C++ class library of cryptographic algorithms) and protocol suites that work in a coherent manner to create one or more time-dependent trust relationships for secure access to content and transactions. The time (e.g., the Secure Clock) is provided by the eSE (secure element). This will be useful for medical records book keeping, and a person's other confidential information (e.g., police record, tax information, etc.) tracking in a world where information, sometimes very personal information, is hosted in public cloud servers. Information can be made available to each party, but with the consent and approval of the owner of the information. An insurance company, for instance, may not be authorized to have access to a particular individuals records, unless that particular individual specifically allow them use of such information. The use of one or more sets of protocols and DRM becomes important in the information age of the future for information and privacy right protection.

The use of a secure hardware communication device (e.g., an eSE or a communication device including at least one secure element therein) may be used as one means by which false identity may be avoided or eliminated. For example, in accordance with certain social media networking sites (e.g., Facebook), false or fake identity is one of the largest security problems associated therewith. The use of secure hardware (e.g., eSE) in a mobile communication device (e.g., a mobile phone, tablet, laptop, personal digital assistant, touchpad device, etc.) may be used to secure identity for a user of such a social media networking site. For example, the use of such a secure hardware device can ensure the secure identity as well as the integrity of content provided from that secure hardware device to and via a social media networking site. A social media networking service provider, or any other cloud service user, can use such pre-authorized eSE information to validate content and/or identity of any one or more users in a given group (e.g., Facebook) or to the service provider. For example, such identity and/or content information is digitally signed by the operator and includes all the needed information residence there with. The third-party provider (e.g., Facebook application, cloud application, etc.) may then read and verify this information via a secure channel between the secure hardware (e.g., such as via an eSE) and the application/service provider. By using the secure hardware, a shadow identity can be created to enable privacy protection of the user (e.g., identity, content, etc.). In this case, a user's real identity may be kept in a secure hardware and only the valid shadow identity is provided to the different service providers/application which can acknowledge or verify that this corresponds to or is a valid person.

In one possible embodiment, a DRM scheme may allow for the use of the generation of certain information (e.g., e-book format DRM) to allow for these secure protection of more than one individual content but instead to a group of content (e.g., in individual's medical records, academic records, legal records, etc.). In such an instance, a relatively larger amount of content, besides just one particular file, may be secured (e.g., in an encrypted form). A secure player (e.g., a Kindle) may be employed in that particular secure player were implemented to include specialized security hardware (e.g., eSE secure element), and trusted and authenticated application (e.g., signed by a well-known and trusted entity such as a third-party service provider such as Facebook, LinkedIn, MySpace, etc.). A hardware based secure element (HSE) based solution may be employed to increase the level of security and prevent hacking by keeping the keys secure in a protected hardware and by signed and secure operating system (OS).

In addition, such techniques and concepts may be extended to controlling the number of times or accesses that a particular portion of content may be accessed, downloaded, printed, etc. (e.g., such as providing a particular limited number of digital copies of the media each having the same or different respective expiration times). For example, the particular constraints associated with a given copy of content may be enforced by a secure element hardware and by dedicated code (e.g., like a specific applet from a service provider such as Facebook) for such security of records. This may also extend to allowing one or more other users have rights to use content retrieved from the cloud, but not have local access, etc. In addition, as will be understood herein, secure access to content may be granted and revoked a different respective times. Generally speaking, a given communication device (e.g., any of those described herein including Facebook phone or Facebook applet (which can be signed and verify by the secure hardware like eSE) may provide a secure vehicle for producing, automatically signing and hosting such a viewer of such content to be shared among and between different respective users.

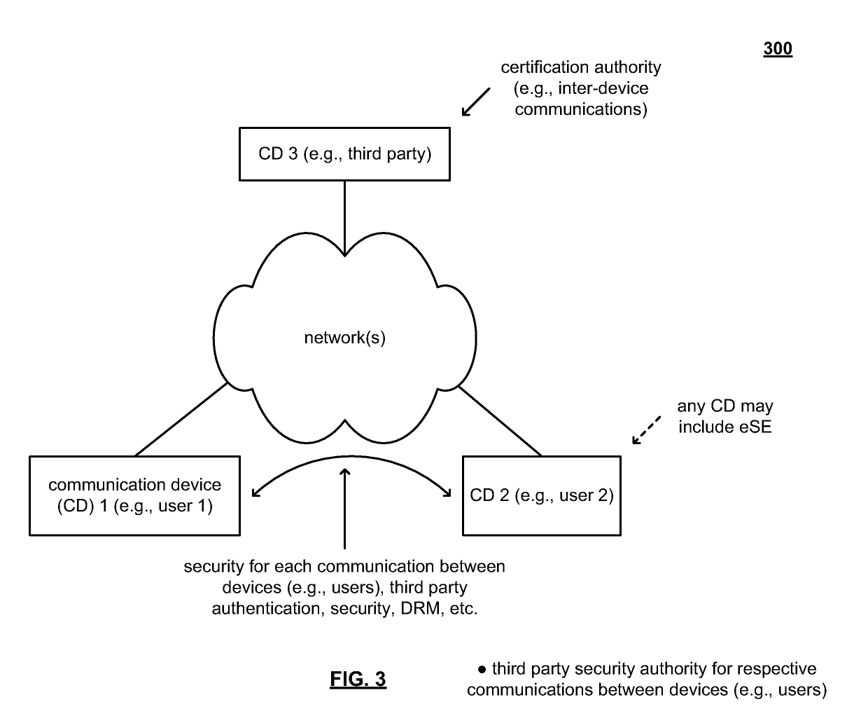

FIG. 3 illustrates an embodiment 300 of a third party operating as a security authority for respective communications between communication devices. As may be understood with respect to this diagram, different respective communication devices may be associated with different respective entities. A first CD may be associated with the first user, a second CD may be assisted with a second user, and a third CD may be associated with third-party (e.g., a service provider such as Facebook, LinkedIn, MySpace, etc.). The third-party operates to provide security with respect to each communication or each respective portion of content provided between respective users, such as those associated with first CD and second CD. In contrast to providing security the authentication to a website, a novel means is provided herein by which respective users may authenticate and verify themselves one to another. For example, a website or cloud server may be implemented to know or verify the particular identity of various users, and the website or cloud server may serve as a certificate authority (CA) to issue public and/or private keys to respective users. Again, it is noted that such security may be viewed as being implemented on a content by content basis such that each individual portion of content to be shared and provided between users is signed in securely shared.

Generally speaking, the third-party device associated with the third CD serves as a trusted entity as both a sender and recipient of content, and this third-party device establishes appropriate forms of security mechanisms among the various users (e.g., via secure key, via identity validation performed beforehand, etc.).

With respect to this diagram, two respective users interact with one another via their respective communication devices in communicating content and/or identity via one or more networks. In some embodiments, any such network may be associated with those communication systems described with reference to FIG. 1. From certain perspectives, the third CD associated with a third party may be viewed as an intermediary trusted third-party who serve to pair up content and or identity to be shared from one CD associated with one user to another CD associated with another user. It is of course noted that such secure sharing of content and identity may be bidirectional in certain embodiments. In addition, it is noted that individual users may operate via the service provider to ensure or set certain rules by which one or more other users may gain access to their content (e.g., via one or more authentication, authorization, and accounting (AAA) protocols which may vary per content, per user, etc.).

In addition, in certain embodiments, it is noted that such authentication and security as provided herein may be viewed as being bidirectional, in that, both respective users associated with the exchange of content and/or identity may authorize and approve of such a secure and authorize exchange.

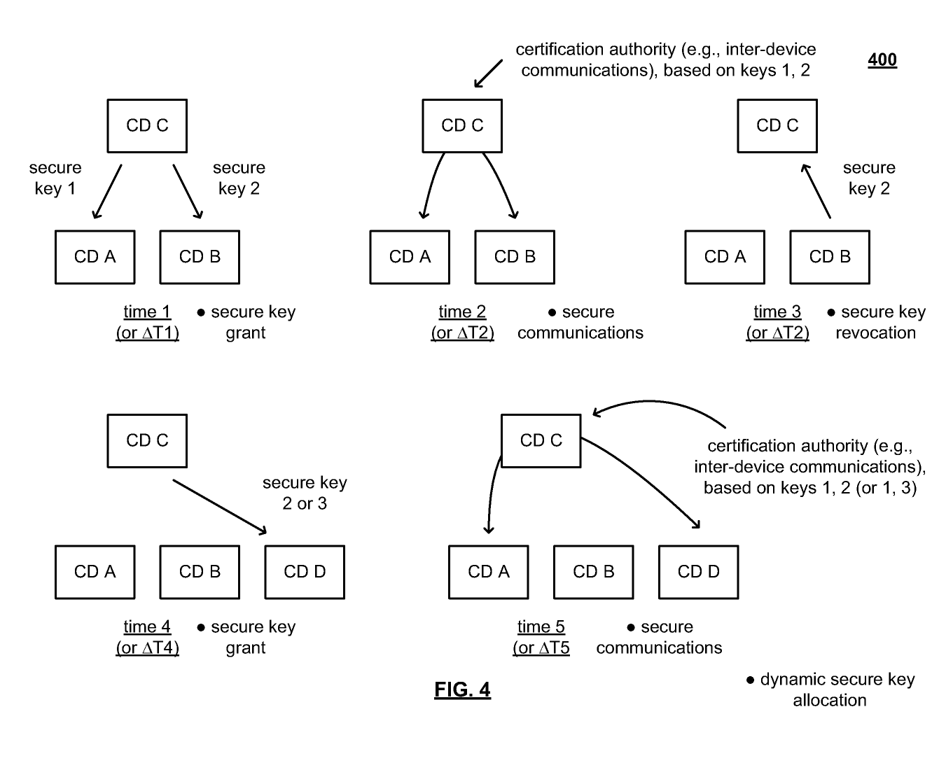

FIG. 4 illustrates an embodiment 400 of dynamic secure key allocation among various communication devices. As may be seen with respect to this diagram, with respect to different times or time periods, different respective operations are performed in accordance with ensuring secure sharing of information between users associated with different respective communication devices. During a first time or time period, one or more secure keys (e.g., such as in accordance with PKI (public key infrastructure)) are distributed from a given communication device to one or more other devices., Then, during a second time or time period, secure communication between the respective devices that have been granted secure key access may be performed. During the third time or time period, a given team may be revoked by the device serving as the certificate authority (CA).

In certain embodiments, during a fourth time or time period, the same secure key that had been revoked from one of the devices or another secure key may be granted to another device. Then, during a fifth time or time period, secure communication may be effectuated between those devices currently having secure keys in accordance with the DRM associated with the operation provided by the device operating as the CA.

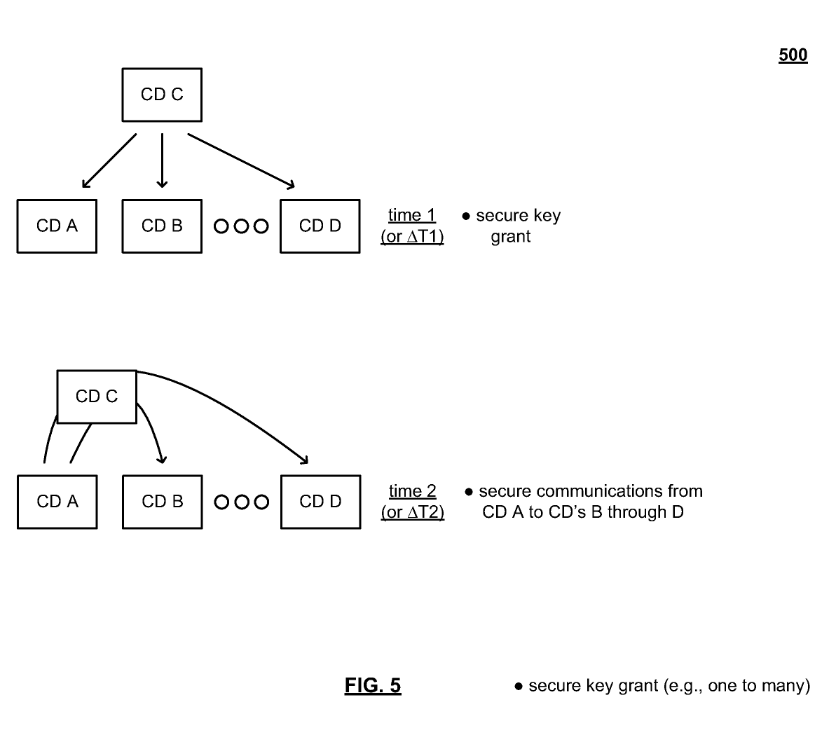

FIG. 5 illustrates an embodiment 500 of a secure key grant among various communication devices. As may be seen dissected this diagram, during a first time or time period, secure keys may be granted to more than one device from a device operating as a CA. After the securities have been granted to these devices, secure communications may be effectuated from a first of the devices having a secure key to those other of the devices having a secure key authorizing the secure communication of content and/or in accordance with the DRM established by the first of the devices and or the device operating as the CA. As also noted with respect to other embodiments herein, it is noted that a device operating as a CA may serve to set one or more rules associated with DRM, and the first of the devices seeking to share content and/or identity to other devices may use those same rules associated with DRM and or modify them to some degree (e.g., ignore certain rules, and certain additional rules, etc.).

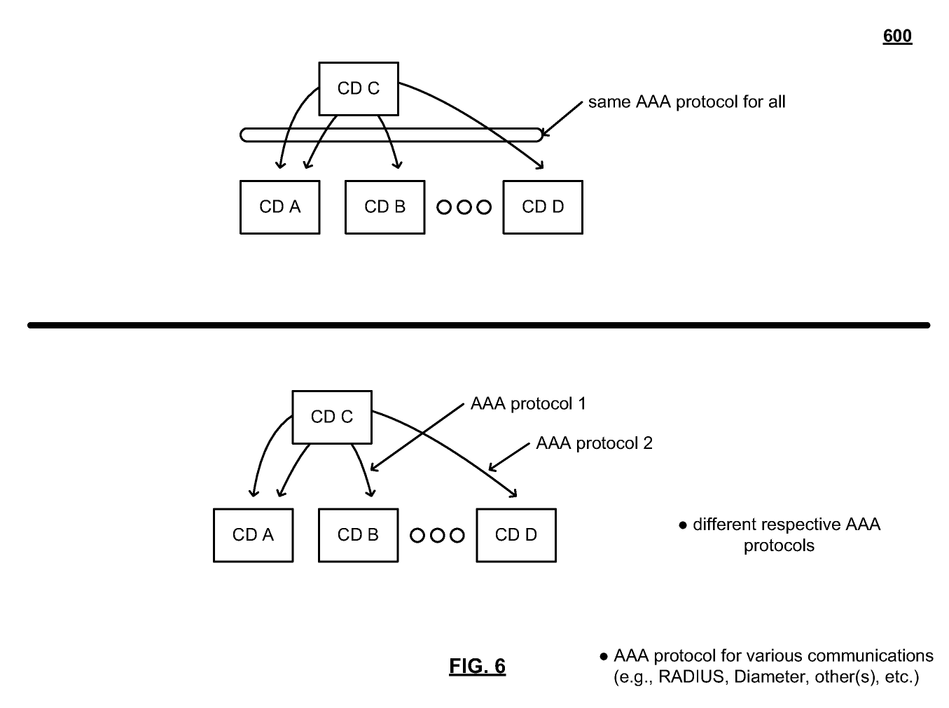

FIG. 6 illustrates an embodiment 600 of using at least one authentication, authorization, and accounting (AAA) protocol for various communications between communication devices. As may be seen as respect to the top portion of this diagram, a same authentication, authorization, and accounting (AAA) protocol may be employed for communications between all respective devices within a given system as moderated by one of the devices serving as a CA.

As may be seen with respect to the bottom portion of the diagram, different respective AAA protocols may be employed respectively for communications between different respective pairs of devices within the system as moderated by one of the devices serving as a CA.

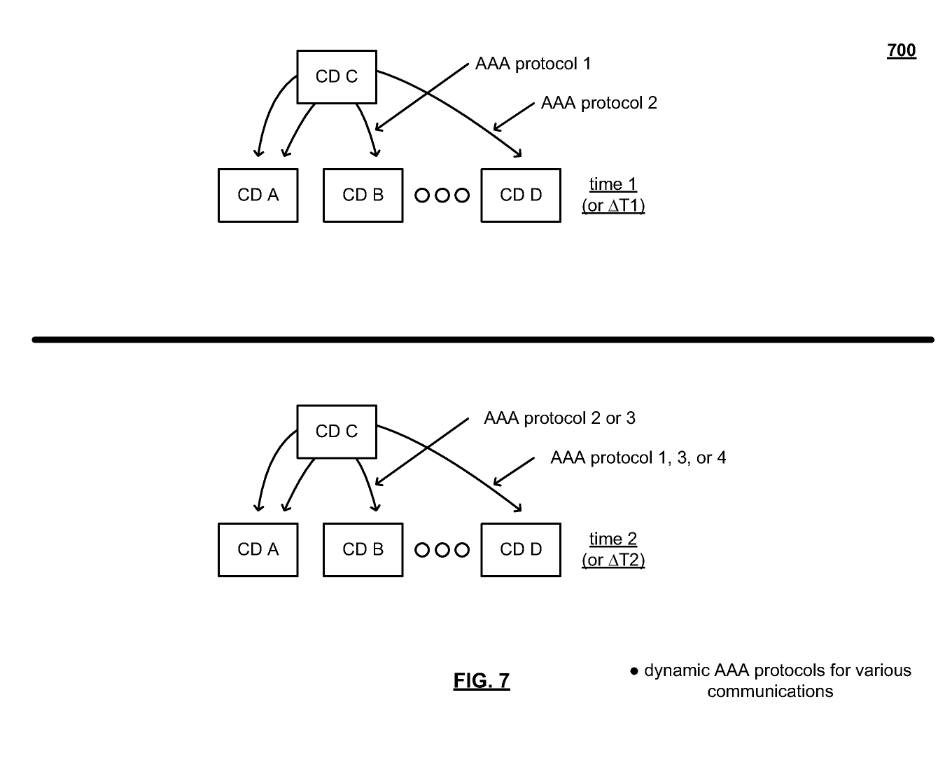

FIG. 7 illustrates an embodiment 700 of dynamic AAA protocol allocation for various communications between communication devices. With respect to the use of different AAA protocols which may be employed respectively for communications between different respective pairs of devices within the system as moderated by one of the devices serving as a CA, the same AAA protocol need not necessarily be employed between any given pair of devices within the system at all times. For example, a first respective AAA protocol may be employed for a given pair of devices during a first time, then a different respective AAA protocol may be employed for that same pair of devices during a second time. Generally speaking, dynamic allocation and use of different respective AAA protocols may be employed for different respective device pairing at different respective times.

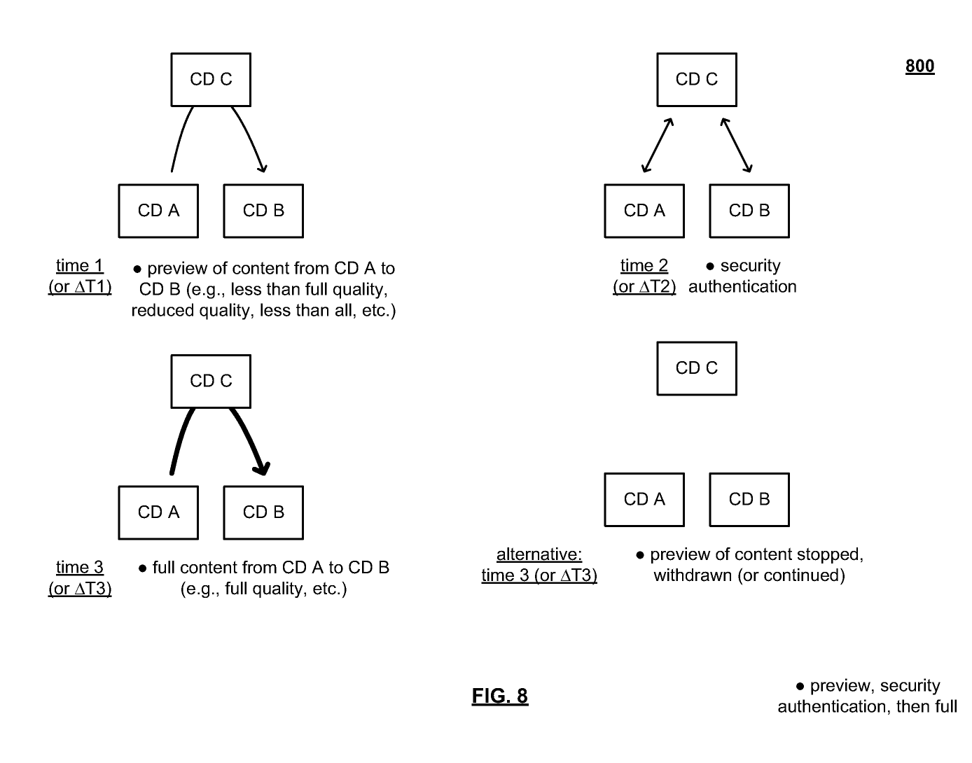

FIG. 8 illustrates an embodiment 800 of content preview, security authentication, and selective full content provision among various communication devices. With respect to this diagram, a first device can provide a preview of content (e.g., corresponding to a less than full quality, reduce quality, less than all, etc. of the content) to a different respective user within the system as moderated by one of the devices serving as a CA.

For example, such a lower resolution copy of the content may be associated with blurring of critical information so users cannot read or view the content easily without proper authentication, but a preview of the content is nonetheless provided. For example, this may be implemented using any of a variety of different schemes including edge detection and information bit smearing in digital images and videos, etc. The encrypted content and/or the critical content may then undergo passing via the secure software which may be protected and authentication/security enforced by secure hardware (e.g., eSE) which may be implemented to perform content and/or user validation and authentication and, if authorized, then they identity and/or content may be decrypted to provide the recipient user with a full version of the content (e.g., full document content). Otherwise, without appropriate security authentication, the recipient user may only see partial information (e.g., that preview of information) which may be provided prior to any security authorization (e.g., and may be provided without any security or free of charge to any potential recipient user).

In addition, it is noted that various embodiments herein reference the communication of content and/or identity between devices. It is of course noted that certain embodiments operate such that a user may be associated with a given device at any given time. In addition, a given user may be associated with the first device at a first time, a second device and the second time, etc. Security herein may be viewed as that which is associated with content and/or identity associated with the user using a given device at a particular time. Again, appropriate DRM, which may be employed on an individual content basis, can ensure that a given user may be afforded the security and protection of content and/or identity provided by or from that user.

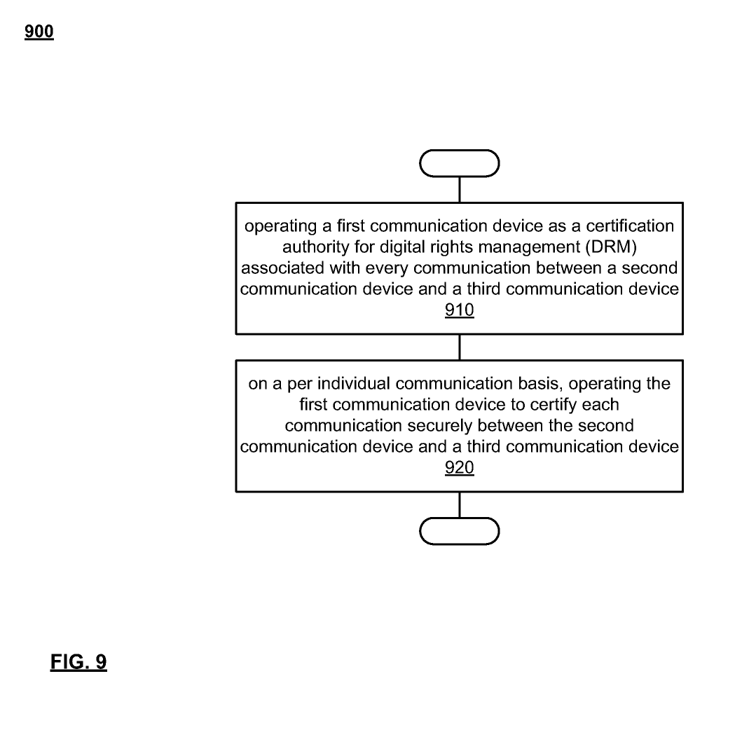

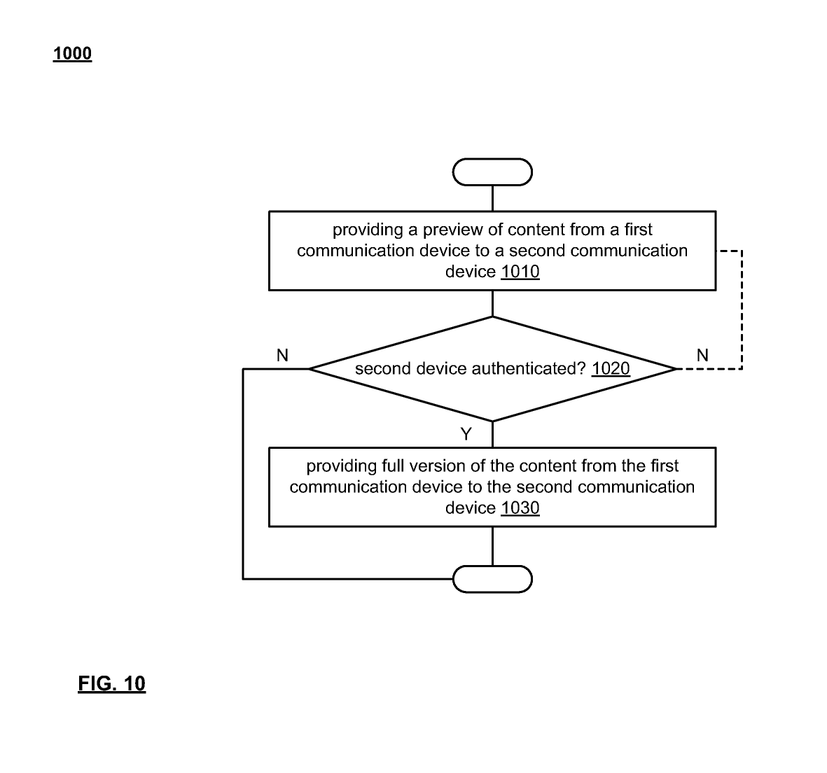

FIG. 9 and FIG. 10 illustrate various embodiments of methods for operating one or more communication devices.

Referring to method 900 of FIG. 9, the method 900 begins by operating a first communication device as a certification authority for digital rights management (DRM) associated with every communication between a second communication device and a third communication device, as shown in a block 910. Then, on a per individual communication basis, the method 900 continues by operating the first communication device to certify each communication securely between the second communication device and a third communication device, as shown in a block 920.

Referring to method 1000 of FIG. 10, the method 1000 begins by providing a preview of content from a first communication device to a second communication device, as shown in a block 1010. Then, as shown in a decision block 1020, the method 1000 continues by determining whether or not a second device has been authenticated, as shown in a block 1020. If it is determined that the second device has in fact been authenticated, then the method 1000 continues by providing a full version of the content from the first communication device the second communication device, as shown in a block 1030.

However, if it is determined that the second device has not been authenticated, then any one of a number of different options may be performed. For example, the method 1000 may continue to perform the operation associated with the block 1010. Alternatively, the method 1000 may end. In even another embodiment, the method 1000 may operate by continuing to provide the preview of the content for a particular period of time, and then cease to provide the preview of the content (e.g., Make the content unavailable for viewing in even a preview format).

It is also noted that the various operations and functions as described with respect to various methods herein may be performed within a variety of types of communication devices, such as using one or more processors, processing modules, etc. implemented therein, and/or other components therein including one of more baseband processing modules, one or more media access control (MAC) layers, one or more physical layers (PHYs), and/or other components, etc.

In some embodiments, such a processor, circuitry, and/or a processing module, etc. (which may be implemented in the same device or separate devices) can perform such processing to generate signals for communication with other communication devices in accordance with various aspects of the invention, and/or any other operations and functions as described herein, etc. or their respective equivalents. In some embodiments, such processing is performed cooperatively by a first processor, circuitry, and/or a processing module, etc. in a first device, and a second first processor, circuitry, and/or a processing module, etc. within a second device. In other embodiments, such processing is performed wholly by a processor, circuitry, and/or a processing module, etc. within a singular communication device.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module”, “module”, “processing circuit”, and/or “processing unit” (e.g., including various modules and/or circuitries such as may be operative, implemented, and/or for encoding, for decoding, for baseband processing, etc.) may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory (ROM), random access memory (RAM), volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a functional block that is implemented via hardware to perform one or module functions such as the processing of one or more input signals to produce one or more output signals. The hardware that implements the module may itself operate in conjunction software, and/or firmware. As used herein, a module may contain one or more sub-modules that themselves are modules.

While particular combinations of various functions and features of the present invention have been expressly described herein, other combinations of these features and functions are likewise possible. The present invention is not limited by the particular examples disclosed herein and expressly incorporates these other combinations.

What is claimed is:

1. An apparatus, comprising:
a first communication device corresponding to a first user;
a second communication device corresponding to a second user; and
a third communication device to:
operate as a certification authority for digital rights management (DRM) associated with every communication between the first communication device and the second communication device;
operate as the certification authority using public-key infrastructure (PKI) for the first communication device and the second communication device; and
employ an authentication, authorization, and accounting (AAA) protocol to effectuate a secure economic transaction associated with media transferred between the first communication device and the second communication device.

2. The apparatus of claim 1, wherein:
during a first time or time period, the third communication device to operate as the certification authority for DRM associated with every communication between the first communication device and the second communication device; and
during a second time or time period, the third communication device to operate as the certification authority for DRM associated with every communication between the first communication device and a fourth communication device.

3. The apparatus of claim 1, wherein:
during a first time or time period, the third communication device to grant a first security key to the first communication device and a second security key to the second communication device; and
during a second time or time period, the third communication device to revoke at least one of the first security key from the first communication device and the second security key from the second communication device and to grant a third security key to a fourth communication device.

4. The apparatus of claim 1, wherein:
at least one of the first communication device and the second communication device includes hardware operative as an embedded secure element (eSE).

5. The apparatus of claim 1, wherein:
the first communication device, the second communication device, and the third communication device operative within a communication system being at least one of a satellite communication system, a wireless communication system, a wired communication system, a fiber-optic communication system, and a mobile communication system.

6. An apparatus, comprising:
a first communication device corresponding to a first user;
a second communication device corresponding to a second user; and
a third communication device to operate as a certification authority for digital rights management (DRM) associated with every communication between the first communication device and the second communication device.

7. The apparatus of claim 6, wherein:
during a first time or time period, the third communication device to operate as the certification authority for DRM associated with every communication between the first communication device and the second communication device; and
during a second time or time period, the third communication device to operate as the certification authority for DRM associated with every communication between the first communication device and a fourth communication device.

8. The apparatus of claim 6, wherein:
during a first time or time period, the third communication device to grant a first security key to the first communication device and a second security key to the second communication device; and
during a second time or time period, the third communication device to revoke at least one of the first security key from the first communication device and the second security key from the second communication device and to grant a third security key to a fourth communication device.

9. The apparatus of claim 6, wherein:
the third communication device to operate as the certification authority using public-key infrastructure (PKI) for the first communication device and the second communication device.

10. The apparatus of claim 6, wherein:
the third communication device to employ an authentication, authorization, and accounting (AAA) protocol to effectuate a secure economic transaction associated with media transferred between the first communication device and the second communication device.

11. The apparatus of claim 6, wherein:
at least one of the first communication device and the second communication device includes hardware operative as an embedded secure element (eSE).

12. The apparatus of claim 6, wherein:
prior to authentication of the first communication device or the second communication device by the third communication device, the third communication device to provide a reduced quality preview of a file to the first communication device or the second communication device; and
after authentication of the first communication device or the second communication device by the third communication device, the third communication device to provide a full quality version of the file to the first communication device or the second communication device.

13. The apparatus of claim 6, wherein:
the first communication device, the second communication device, and the third communication device operative within a communication system being at least one of a satellite communication system, a wireless communication system, a wired communication system, a fiber-optic communication system, and a mobile communication system.

14. A method for operating a first communication device, the method comprising:
operating the first communication device as a certification authority for digital rights management (DRM) associated with every communication between a second communication device and a third communication device; and wherein:
the second communication device corresponding to a first user; and
the third communication device corresponding to a second user.

15. The method of claim 14, further comprising:
during a first time or time period, operating the first communication device to operate as the certification authority for DRM associated with every communication between the second communication device and the third communication device; and
during a second time or time period, operating the first communication device to operate as the certification authority for DRM associated with every communication between the second communication device and the third communication device.

16. The method of claim 14, further comprising:
operating the first communication as the certification authority using public-key infrastructure (PKI) for the second communication device and the third communication device;
during a first time or time period, operating the first communication device to grant a first security key to the second communication device and a second security key to the third communication device; and
during a second time or time period, operating the first communication device to revoke at least one of the first security key from the second communication device and the third security key from the third communication device and to grant a third security key to a fourth communication device.

17. The method of claim 14, further comprising:
operating the first communication device to employ an authentication, authorization, and accounting (AAA) protocol to effectuate a secure economic transaction associated with media transferred between the second communication device and the third communication device.

18. The method of claim 14, wherein:
at least one of the second communication device and the third communication device includes hardware operative as an embedded secure element (eSE).

19. The method of claim 14, further comprising:
prior to authentication of the second communication device or the third communication device by the first communication device, operating the first communication device to provide a reduced quality preview of a file to the second communication device or the third communication device; and
after authentication of the second communication device or the third communication device by the first communication device, operating the first communication device to provide a full quality version of the file to the second communication device or the third communication device.

20. The method of claim 14, wherein:
the first communication device, the second communication device, and the third communication device operative within a communication system being at least one of a satellite communication system, a wireless communication system, a wired communication system, a fiber-optic communication system, and a mobile communication system.
